(19) United States
(12) Patent Application Publication
(10) Pub. No.: US 2009/0106107 A1
(43) Pub. Date: Apr. 23, 2009

(54) Smart Digital Advertising Method

(75) Inventors: Joachim Guenster, Baldham (DE); Thomas Binzinger, Baldham (DE)

Correspondence Address: AC TECHNOLOGIES, S.A., MAISON 2, LEITHUM, 9910, LU

(73) Assignee: AC TECHNOLOGIES S.A., Leithum (LU)

(21) Appl. No.: 12/253,248

(22) Filed: Oct. 17, 2008

Related U.S. Application Data
(60) Provisional application No. 60/980,982, filed on Oct. 18, 2007.

(51) Int. Cl. G06Q 30/00; H04W 4/12

(52) U.S. Cl. 705/14; 455/466

(57) ABSTRACT

A method for delivering a message that contains a data packet consisting of a header part and a body part. Authorised recipients are allowed to receive the data packet in its entirety. Authorised recipients may retransmit the message to external recipients who are only allowed to receive the header part of the original data packet. External recipients may request to the system delivering of the body part of the data packet. The method enables the automatic recognition of external recipients followed by the delivery of the header part of the data packet.

### CROSS-REFERENCE TO RELATED APPLICATIONS

This application claims priority from U.S. Provisional Patent Application Ser. No. 60/980,982, filed on 18 Oct. 2007 and entitled “Smart Digital Advertising Method”, the contents of which are hereby fully incorporated by reference.

### BACKGROUND OF THE INVENTION

1. Field of the Invention

The present invention relates to the field of digital advertising.

2. Description of the Related Art

More and more mobile devices are in use in the world and are having a pervasive impact on the society as daily communication method. In recent years, Internet functionality has been integrated to such devices and many people now use the Internet and its related services and applications through their cell phones, smart phones, blackberries and other devices. Along with this Internet functionality, Short Message Service (SMS) has become the most popular mobile application nowadays, representing a common and popular way of social interaction used by an infinite number of mobile users on daily basis. Because of this, there is a general and growing interest in every industry to use mobile devices and applications for advertising.

This has originated the development of different applications for sending advertisement to mobile devices embodied in the form of SMS, MMS, electronic mail or any other similar data communication method. However, according to the conventional digital advertising methods, distribution of the advertising content is a centralized function of the system in which a central computer unit/server is normally responsible for sending the adds to mobile devices in a network. The cost of this transmission is charged to the advertising entity and the targeting of the consumer is normally made by applying different methods like surveys or monitoring of consumer preferences, among many others.

The present invention has been conceived to provide advertising entities with an innovative method to distribute their contents to consumers and by consumers, sending data packages to a certain number of recipients, which perform the further distribution of the whole data packet or only a certain part thereof depending on predetermined parameters. Thereby, the method also allows for reducing the costs related to distribution of the advertising content and targeting of consumers.

### SUMMARY

The present invention refers to an innovative advertising method that generates data packages containing a header and a body part to be distributed within data communication networks according to predetermined parameters.

Generally, the invention allows for automatically differentiate between the status of the recipients to prevent them for receiving the entire data packet. Further steps of the method allow recipients, originally prevented from receiving the whole data package, to receive it in its entirety upon request. This allows promoters or advertisers to bill the recipients for receiving the entire data package, to use recipients for further distribution of the data packages and to capture new potential consumers by using such recipients as targeting entities.

Other objects and advantages of the present invention will become apparent from the following description, taken in connection with the accompanying flowchart, wherein, by way of illustration and example, the preferred embodiment of the present invention is disclosed.

### BRIEF DESCRIPTION OF THE DRAWINGS

The above objects and features of this invention will be become more apparent through detailed descriptions of the preferred embodiments and with reference to the flowchart annexed hereto.

FIG. 1 is a flowchart illustrating the Smart Digital Advertising Method according to its preferred embodiment.

### DETAILED DESCRIPTION OF THE INVENTION

The invention refers to a digital advertising method. The method allows for delivering messages consisting of a data packet split in a header part and a body part. Authorised recipients are allowed to receive the data packet in its entirety. They may also retransmit the message to external recipients. In this case, part of the data encoded on the message is programmed to prevent external recipients from receiving the message in its entirety. More specifically, external recipients are only allowed to receive the header part of the message. If so desired, external recipients may request to the system the delivery of the body part thereof.

In a preferred embodiment, the method allows for advertising and promoting products and services by using mobile users as means of distribution and propagation of the information. The advertisement, publicity or promotion is accompanied by different advantages, such as, but not limited to, prizes, bonus, coupons, credit notes, gift certificates or any other similar advantage or gain for the recipient. The content of the advertisement or promotion as well as their respective accompanying advantage is all encoded in a binary data packet embodied in a SMS. The data packet is split in two parts: the header part and the body part. The header part contains the information related to the advertisement or promotion itself. The body part contains the accompanying advantage. Authorised recipients are allowed to receive the header and body parts comprised in the data packet in a single SMS. External recipients receive only the header of the data packet. If so desired, external recipients may request the delivery of the body part of the data packet.

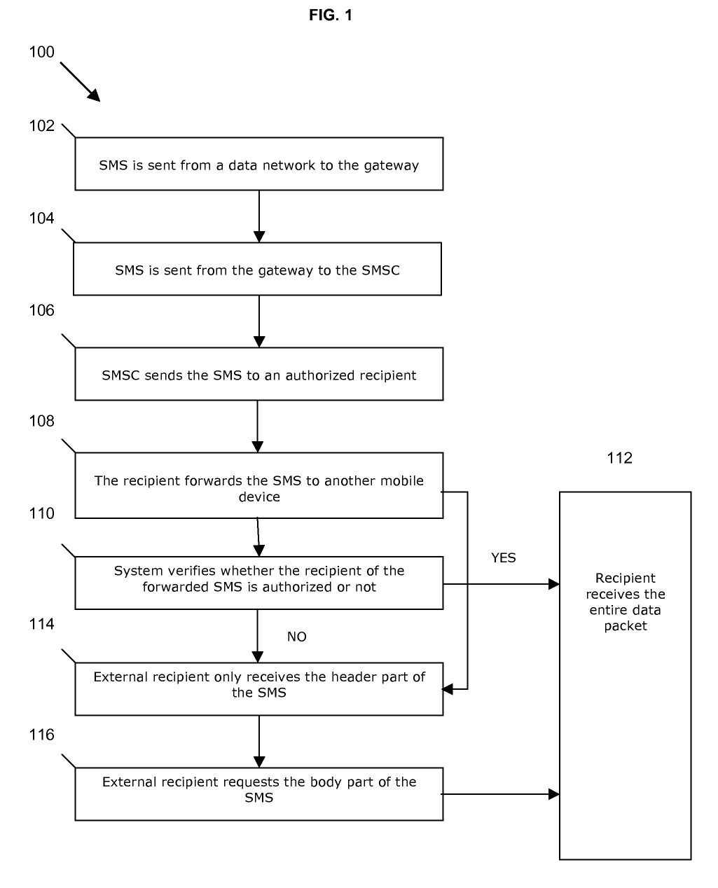

FIG. 1 is a flowchart illustrating the method of sending data packages embodied in a SMS to mobile users according to the preferred embodiment of the present invention. In a first operation mode, the system sends a SMS to the mobile terminal of the authorised recipient from the Internet or any other similar data network. To send the SMS to the authorised recipient, the computer of the system transmits the programmed SMS to a converter, a so-called gateway (102). This gateway enables to transmit a SMS from a data network to a mobile device. From the gateway, the SMS is forwarded to the Short Message Service Center (SMSC) of the respective telecommunication network (104) from which the SMS is finally delivered on the recipient's mobile terminal (106). In this specification, the term mobile terminal and mobile device are used irrespectively and refer, without being limited to, mobile phones, smart phones and blackberries devices.

As mentioned above, the SMS carries the data packet, which consists of a header and a body part. The authorised recipient receives the header and body part of the data packet in a single SMS. When the authorised recipient forwards the original SMS to another mobile device, data encoded on the SMS prevents the external recipient from receiving the entire data packet, therefore receiving the header part only (114). In order to obtain the body part, the external recipient sends a request to the system via SMS (116). It must be noted that in this operation mode, the system sends the original SMS to any authorised recipient. Therefore, any retransmission of this original SMS is automatically considered to be addressed to external recipients. Thus, the original SMS is already programmed to prevent the transmission of the whole data packet in case of forwarding.

In a different operation mode of the preferred embodiment, the system sends the original SMS to a certain number of authorised recipients only (106). These authorised recipients may forward the SMS either to other authorised recipients or to external ones (108). In order to identify the category of recipients, the forwarded SMS is sent to the system for identification of the recipient. The system compares the recipient's mobile number with its database and recognizes the number as authorised or external (110). In the first case (authorised recipients), the system delivers the original SMS that contains the whole data packet (112). In the second case (external recipients), the system only delivers the header part of the original SMS (114). In order to obtain the body part, the external recipient has to send a request to the system via SMS (116). Although the original data packet has been exclusively described herein as being embodied in a SMS, the method may use any other messaging system i.e. multimedia messaging service (MMS) or email. In this way, the header and the body part of the message may comprise, without being limited to, text, rich text, logos, pictures, audio, video or any other similar digital content.

The method also allows for applying certain parameters to send the body part of the data packet without need of express request by the external recipient. By way of example only, if the external recipient is located within a predetermined location, the method allows for recognizing such location and sending an advantage that is only valid when the external recipient enters such location i.e. a discount in a shop located in a specific shopping mall of the city.

In another embodiment, the system sends an email to an authorised recipient. The email consists of a header part and a body part. It also may be, without being limited to, text or image based or a combination of both. When the authorised recipient forwards the email to another email addresses, the method allows for recognizing those recipients as authorised or external. In the first case, the authorised recipient receives the original email that contains the whole data packet. In the second case, the method only allows for delivering the header part of the email to the external recipient. In order to obtain the body part of the email, the external recipient should send a response to the system. This response may consist of, without being limited to, a SMS, reverse billing SMS, email answer or a registration form.

The method can be used for any company intended to promote or advertise a product or service. For example, registered clients of a company become authorised recipients of the system provided they agree on receiving the advertisement or promotion information as well as its respective accompanying advantage. Usually, authorised recipients may also have an interest in letting other people to participate in the advantage of the promotion, therefore forwarding the information to their contacts. In this case, the system only provides the advertisement or promotion information (header part) and if so desired, external recipients may answer back to the original message in order to obtain the accompanying advantage (body part). This gives the promoter or advertiser the opportunity of billing for receiving the advantage and adding new users to its database, among others. In this way, the advertiser or promoter may request the kind of response that better servers its business approaches or goals. It must be understood that applications described above are cited only to illustrate some of the uses of the invention without limiting other services that may be offered by using the method.

1. A digital advertising method, comprising the steps of:
a) creating a message consisting of a binary data packet, said data packet consisting of a header part and a body part, said header part containing advertisement, said body part containing an accompanying advantage to said advertisement;
b) sending the entire data packet to the mobile device of each authorised recipient;
c) allowing each authorised recipient to retransmit the data packet to at least one external recipient; said data package being programmed to prevent said external recipient from receiving the body part of the message; and;
d) sending the body part of the message to said external recipient upon request;
whereby said external recipient can also retransmit the header part of the message to other external recipients.

2. The method according to claim 1, further including the use of a payment service to charge the external recipient for receiving the body part of the message.

3. The method according to claim 1, further including creating a database of the external recipients upon authorisation of said external recipients.

4. A digital advertising method, comprising the steps of:
a) creating a message consisting of a binary data packet, said data packet consisting of a header part and a body part, said header part containing advertisement, said body part containing an accompanying advantage to said advertisement;
b) sending said data packet to the mobile device of at least one authorised recipient, said authorised recipient being allowed to retransmit the data packet to at least one more authorised recipient; and a at least one external recipient;
c) identifying authorised recipients and external recipients;
d) allowing authorised recipients to receive the header part and the body part of the data packet;
e) allowing external recipients to receive the header part of the message; and;
f) sending the body part of the message to said external recipients upon request;
whereby authorised and external recipients are allowed to retransmit the data packet wholly or partially to other mobile devices according to letters (d) and (e).

5. The method according to claim 4, further including the use of a payment service to charge the external recipient for receiving the body part of the message.

6. The method according to claim 4, further including creating a database of the external recipients upon authorisation of said external recipients.

7. A digital advertising method, comprising the steps of:
a) creating a message consisting of a binary data packet, said data packet consisting of a header part and a body part, said header part containing advertisement, said body part containing an accompanying advantage to said advertisement;
b) sending the entire data packet to at least one authorised recipient; said authorised recipient being allowed to retransmit the data packet to other authorised recipients;
c) allowing said at least one authorised recipient to retransmit the data packet to at least one external recipient; said data package being programmed to prevent said external recipient from receiving the body part of the message; and; said external recipient being also able to retransmit the header part of the message to other external recipients; and;
d) sending the body part of the data packet to said external recipients upon compliance with predetermined parameters, said data packet being programmed to identify compliance with said predetermined parameters.
